(19) United States
(12) Patent Application Publication
(10) Pub. No.: US 2011/0233497 A1
(43) Pub. Date: Sep. 29, 2011

(54) WIRE FENCING

(76) Inventor: Kenneth Leslie Forge, Mulwala (AU)

(21) Appl. No.: 12/731,327

(22) Filed: Mar. 25, 2010

(51) Int. Cl. E04H 17/06; F16B 2/00

(52) U.S. Cl. 256/47; 24/458

(57) ABSTRACT

A plug for retaining wire on a substantially vertical elongate post having an inverted substantially L-shaped slot that opens into a substantially horizontal elongate wire-introducing portion and ends in a substantially vertical elongate wire-retaining portion, wherein the plug is adapted to friction fit in the wire-introducing portion to substantially horizontally overlap wire previously received in wire-retaining portion.

### FIELD OF THE INVENTION

The present invention relates to wire fencing.

### BACKGROUND OF THE INVENTION

Wire fences are conventionally constructed by tying off each horizontal wire to individual posts. The tying off of individual wires is time-consuming and labour-intensive.

What is needed is a solution for constructing wire fencing which addresses the above difficulties.

### SUMMARY OF THE INVENTION

According to the present invention, there is provided a plug for retaining wire on a substantially vertical elongate post having an inverted substantially L-shaped slot that opens into a substantially horizontal elongate wire-introducing portion and ends in a substantially vertical elongate wire-retaining portion, wherein the plug is adapted to friction fit in the wire-introducing portion to substantially horizontally overlap wire previously received in wire-retaining portion.

The plug can have peripheral flanges that are adapted to substantially overlap portions of the post which define the wire-introducing portion of the slot when the plug is friction fitted therein.

The plug can be a moulding in plastics.

The present invention also provides a wire fencing system including a substantially vertical elongate post having an inverted substantially L-shaped slot which opens into a substantially horizontal elongate wire-introducing portion and ends in a substantially vertical elongate wire-retaining portion, and a plug that is adapted to friction fit in the wire-introducing portion to substantially horizontally overlap wire previously received in wire-retaining portion.

### BRIEF DESCRIPTION OF THE DRAWINGS

The invention will be further described by way of example only with reference to the accompanying drawings, in which:

FIGS. 1 and 2 are respective perspective and side views of an embodiment of a plug of the invention before and after friction fitting to a post;

FIGS. 3 and 4 are respective side and bottom plan views of the plug; and

FIG. 5 is a perspective view of electric fencing insulators fitted to the fence post using the plug.

### DETAILED DESCRIPTION

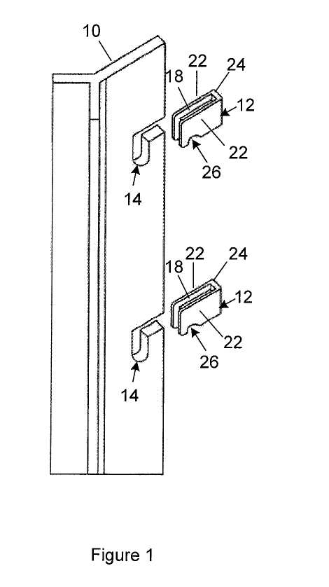

FIG. 1 illustrates an embodiment of a plug 12 of the invention before friction fitting to a fence post 10. The post 10 has one or more slots 14 formed therein to receive a strand of wire. The slots 14 have, for example, an inverted-L shape in vertical cross section. The slots 14 optionally have other equivalent vertical section shapes, for example, L shapes, angled shapes, curve shapes, etc. The slots 14 are regularly or irregularly spaced vertically along the post 10. The post 10 has, for example, a Y-shaped horizontal cross section. The post 10 can have other equivalent horizontal section shapes, for example, T shapes, I shapes, H-shapes, circular shapes, rectilinear shapes, etc. The post 10 is formed, for example, from metal or plastics.

Referring to FIG. 2, each plug 12 is sized and shaped to be friction-fitted into a slot 14 and over a strand of wire 16 received therein to thereby fasten the strand of wire 16 in position on the post 10. The plug 12 is formed, for example, as an integral moulding in plastics. The strand of wire 16 is, for example, barbed wire, wire mesh, smooth wire, and combinations thereof.

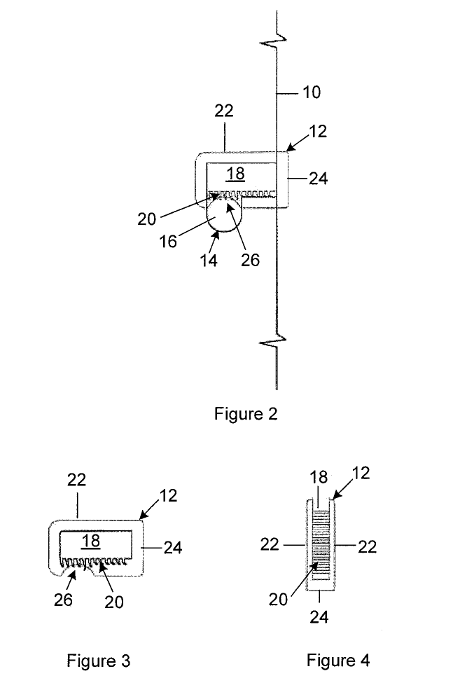

Referring to FIGS. 3 and 4, each plug 12 optionally includes an elongate, generally rectangular horizontal plug body 18 having curved fir tree branches 20 extending thereunder downwardly and rearwardly. Other equivalent fir tree branches 20 may also be used, for example, the curved branches 20 may further or alternatively extend upwardly from the plug body 18. In use, the fir tree branches 20 allow the plug 12 to be friction-fitted into a slot 14 and over the stand of wire 16 with a low insertion force (i.e., the force required to insert the plug 12 into the slot 14) while maintaining a high extraction force (i.e., the force required to withdraw the plug 12 from the slot 14). The plug body 18 may have other shapes which complement the shape of the slots 14.

The plug body 18 is enclosed on three sides by two vertically overlapping side or peripheral flanges 22, and a vertically overlapping rear end flange 24. The plug 12 is generally H-shaped in vertical cross section through the plug body 18 and side flanges 22, and generally squared- U-shaped in horizontal cross section through the side and rear end flanges 22, 24. In use, the plug 12 friction-, press-, snap- or push-fits into the slot 14, and the side flanges flex-fit, clip, snap or clamp around portions of the post 10 adjacent to opposing side edges of the slot 14, as illustrated in FIG. 2. The side flanges 22 prevent the plug 12 from being displaced from the slot 14 in directions generally parallel to the strand of wire 16. Each side flange 22 has a semi-circular cut-out 26 adapted to overlie the strand of wire 16 when in position in the slot 14. The side flanges 22 therefore allow the plug 12 to be snugly flush-mounted around the post 10 and over the strand of wire 16. The side flanges 22 and/or the rear end flange 24 optionally have gripping projections, for example ribbing or flanges (not shown), to aid gripping during insertion and withdrawal of the plug 12 from the slot 14.

Each post 10 has, for example, a plurality of slots 14, and a plurality of plugs 12 are provided for each post 10. The posts 10 and plugs 12 are provided separately or together as a kit of parts. The kit of parts optionally further includes the wire 16.

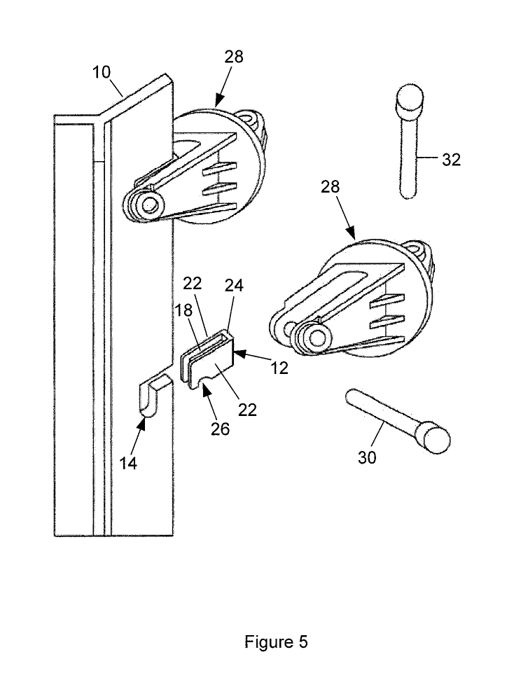

1Referring to FIG. 5, the plug 12 is compatible with electric fencing insulators 28 to fasten strands of electrified wire or tape to the post 10 as part of an electrified fence. Referring to the lower insulator 28, the plug 12 is inserted into a slot 14 in the post 10, and a pin 30 is inserted horizontally through one end of the insulator 28 and through the wire-receiving portion of the slot 14 to thereby fasten the insulator 28 to the post 10. A strand of wire or tape (not shown) to be electrified is then fastened to the free end of the insulator 28 by a vertical pin 32.

It will be appreciated that embodiments of the present invention advantageously allow fencing wire to be easily and securely fastened to fence posts without the need for tying off individual wires.

The embodiments have been described by way of example only and modifications are possible within the scope of the claims which follow.

1. A plug for retaining wire on a substantially vertical elongate post having an inverted substantially L-shaped slot that opens into a substantially horizontal elongate wire-introducing portion and ends in a substantially vertical elongate wire-retaining portion, wherein the plug is adapted to friction fit in the wire-introducing portion to substantially horizontally overlap wire previously received in wire-retaining portion.

2.-4. (canceled)

5. A plug according to claims 1, wherein the plug comprises a plastic moulding.

6. A plug according to claim 1, wherein the plug has peripheral flanges that are adapted to substantially overlap portions of the post which define the wire-introducing portion of the slot when the plug is friction fitted therein.

7. A plug according to claims 6, wherein the plug comprises a plastic moulding.

8. A wire fencing system including a substantially vertical elongate post having an inverted substantially L-shaped slot which opens into a substantially horizontal elongate wire-introducing portion and ends in a substantially vertical elongate wire-retaining portion, and a plug that is adapted to friction fit in the wire-introducing portion to substantially horizontally overlap wire previously received in wire-retaining portion.

9. A plug according to claims 8, wherein the plug comprises a plastic moulding.
